(19) United States
(12) Patent Application Publication
(10) Pub. No.: US 2011/0138343 A1
(43) Pub. Date: Jun. 9, 2011

(54) Pattern Transfer Modeling for Optical Lithographic Processes

(76) Inventor: Yuri Granik, Palo Alto, CA (US)

(21) Appl. No.: 12/710,353

(22) Filed: Feb. 22, 2010

Related U.S. Application Data
(63) Continuation of application No. 12/625,538, filed on Nov. 24, 2009.
(60) Provisional application No. 61/154,271, filed on Feb. 20, 2009.
(60) Provisional application No. 61/117,283, filed on Nov. 24, 2008.

(51) Int. Cl. G06F 17/50

(52) U.S. Cl. 716/54

(57) ABSTRACT

Various implementations of the invention provide for the optimization of etch induced pattern transfer across a significant portion of a design. In various implementations, an entire design, that is a “full-chip” may be optimized. With some implementations, the invention may be employed to detect etch hotspots. Further implementations may be employed in either or both a mask data preparation process (“MDP”) or to determine the etch effects of including various patterns in a design.

### RELATED APPLICATIONS

This application claims priority under 35 U.S.C.§119(e) to U.S. Provisional Patent Application No. 61/154,271 entitled “Extreme Optical Process Correction,” filed on Feb. 20, 2010, and naming Yuri Granik et al. as inventors and is a continuation in part of U.S. patent application Ser. No. 12/625,538 entitled “Visibility and Transport Kernels for Variable Etch Bias Modeling of Optical Lithogrpahy,” filed on Nov. 24, 2009, which application claims the benefit of U.S. Provisonal Patent Application 61/117,283, filed on Nov. 24, 2008, which applications are incorporated entirely herein by reference.

### FIELD OF THE INVENTION

The invention relates to the field of integrated circuit design and manufacturing. More particularly, various implementations of the invention are applicable to jointly calibrating models useful to simulate optical lithographic masks.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (“IC's”).

Several steps are common to most design flows. Initially, a design may typically start at a high level of abstraction, by a designer creating a specification that describes particular desired functionality. This specification, often implemented by a programming language, such as, for example, the C or C++ programming language, describes at a high level the desired behavior of the device. Designers will then typically take this specification for the design and create a logical design, often implemented in a netlist, through a synthesis process. The logical design describes the individual components of the design, and also may have different level of abstraction, such as, for example the gate level or the register level.

A register transfer level (“RTL”) design, often implemented by a hardware description language (“HDL”) such as Verilog, SystemVerilog, or Very High speed hardware description language (“VHDL”), describes the operation of the device by defining the flow of signals or the transfer of data between various hardware components within the design. More particularly, a register transfer level design describes the interconnection and exchange of signals between hardware registers and the logical operations that are performed on those signals.

Typically, a register transfer level design is first synthesized from the specification, followed by a gate level design being synthesized from the register transfer level design. Gate level designs describe the actual physical components such as transistors, capacitors, and resistors as well as the interconnections between these physical components. Often, gate level designs are also implemented by a netlist, such as, for example, a mapped netlist. Lastly, the gate-level design is taken and another transformation is carried out. First by place and route tools that arrange the components described by the gate-level netlist and route connections between the arranged components; and second, by layout tools that generate a layout description having layout “shapes” that may then used to fabricate the electronic device, through for example, an optical lithographic process.

Integrated circuit layout descriptions can be provided in many different formats. The Graphic Data System II (“GDSII”) format is popular for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (“SEMI”). These various industry formats are used to define the geometrical information in integrated circuit layout designs that are employed to manufacture integrated circuits. Once the microcircuit device design is finalized, the layout portion of the design can be used by fabrication tools to manufacturer the device using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask based upon the layout design data, after which the mask can be used in a photolithographic process. The image embodied in the layout data is often referred to as the intended or target image or target contours, while the image created in the mask is generally referred to as the mask contours. Furthermore, the image created on the substrate by employing the mask in a photolithographic process is often referred to as the printed image or printed contours.

As designers and manufacturers continue to increase the number of circuit components in a given area and/or shrink the size of circuit components, the shapes reproduced on the substrate become smaller and are placed closer together. The feature sizes are often referred to by the distance between features, conventionally called the “process step,” or the “node.” For example, one node is the 32 nanometer (“nm”) node. This implies that adjacent features in the design, such as, for example, identical cells in a memory array, are 32 nanometers apart. As process steps are continually scaled down, the corresponding reduction in feature size increases the difficulty of faithfully reproducing the image intended by the layout design onto the substrate.

In order to increase the fidelity of the optical lithographic process, the etch portion of the lithographic process may be optimized. Conventionally, the etching of vias and contact pads are optimization based upon selected patterns from test runs. More particularly, selected patterns from manufactured wafers are identified and the etching process is optimized for these patterns. Unfortunately, these test patterns represent often only a small part of the entire test wafer. Accordingly, the optimized etch process is really only optimized for a small part of the design used to manufacture the test wafer.

Etch rate variation caused by microloading is governed by a large-scale pattern density (“PD”) variation of the order of magnitude of mean free path of gas radical species participating in etch reactions. This scale (i.e. of the effect of etch rate variation) is typically much larger than the patterns used to optimize the etch process. As a result, conventional optimization process typically do not account for the pattern density distribution of layout segments located far from the test pattern. Accordingly, during actual manufacturing, un-accounted for pattern densities may have significant effects on the actual etch transfer.

### SUMMARY OF THE INVENTION

Various implementations of the invention provide for the optimization of etch induced pattern transfer across a significant portion of a design. In various implementations, an entire design, that is a “full-chip” may be optimized. With some implementations, the invention may be employed to detect etch hotspots. Further implementations may be employed in either or both a mask data preparation process (“MDP”) or to determine the etch effects of including various patterns in a design.

Some implementations of the invention derive pattern transfer based upon a model, which includes both a component to represent across-die variation in radical fluxes caused by global pattern density variation (“microloading”) and aspect ratio (“AR”) induced variation in inter-feature radical transport resistance. In various implementations, this is facilitated by deriving a solution to the die-scale diffusion problem with the flux boundary conditions (“BC”) introduced on the “effective reaction surface,” which replaces the wafer surface reaction rate boundary condition.

The later was done by solution of the ballistic transport problem in the sub-surface sub-domain.

### BRIEF DESCRIPTION OF THE DRAWINGS

The present invention will be described by way of illustrative embodiments shown in the accompanying drawings in which like references denote similar elements, and in which:

FIG. 1 illustrates an illustrative computing environment upon which various implementations of the invention may be carried out;

FIG. 2 illustrates an across-die cut 201, showing the average densities;

FIG. 3 illustrates the across-die cut 201, showing the steady-state distribution of carbon fluoride and fluorine radical fluxes;

FIG. 4 illustrates a schematic of the etch portion of an optical lithographic process;

FIG. 5 shows the ion energy loss for a polymer layer;

FIGS. 6A and 6B show the predicted SiO₂ etch rate as a function of ion energy and oxygen in the gas mixture;

FIGS. 7A and 7B show the polymer thickness and SiO2 etch rate as a function of ion energy and amount of oxygen in the gas mixture;

FIG. 8 shows the correlation between predicted etch depths and measured etch depths;

FIG. 9 shows both the measured and predicted etch depths;

FIG. 10 illustrates predicted distributions of radical flux;

FIG. 11 illustrates predicted critical dimension of a via bottom; and

### DETAILED DESCRIPTION OF ILLUSTRATIVE IMPLEMENTATIONS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed methods. Such terms are often high-level abstractions of the actual operations that are performed. The actual operations that correspond to these terms will often vary depending on the particular implementation, and will be readily discernible by one of ordinary skill in the art.

Furthermore, in various implementations of the invention, a mathematical model may be employed to represent an electronic device. With some implementations, a model describing the connectivity of the device, such as for example a netlist, is employed. Those of skill in the art will appreciate that the models, even mathematical models represent real world device designs and real world physical devices. Accordingly, manipulation of the model, even manipulation of the model when stored on a computer readable medium, results in a different device design. More particularly, manipulation of the model results in a transformation of the corresponding physical design and any physical device rendered or manufactured by the device design. Additionally, those of skill in the art can appreciate that during many electronic design and verification processes, the response of a devices design to various signals or inputs is simulated. This simulated response corresponds to the actual physical response the device being modeled would have to these various signals or inputs.

Some of the methods described herein can be implemented by software stored on a computer readable storage medium, or executed on a computer. Accordingly, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

Illustrative Computing Environment

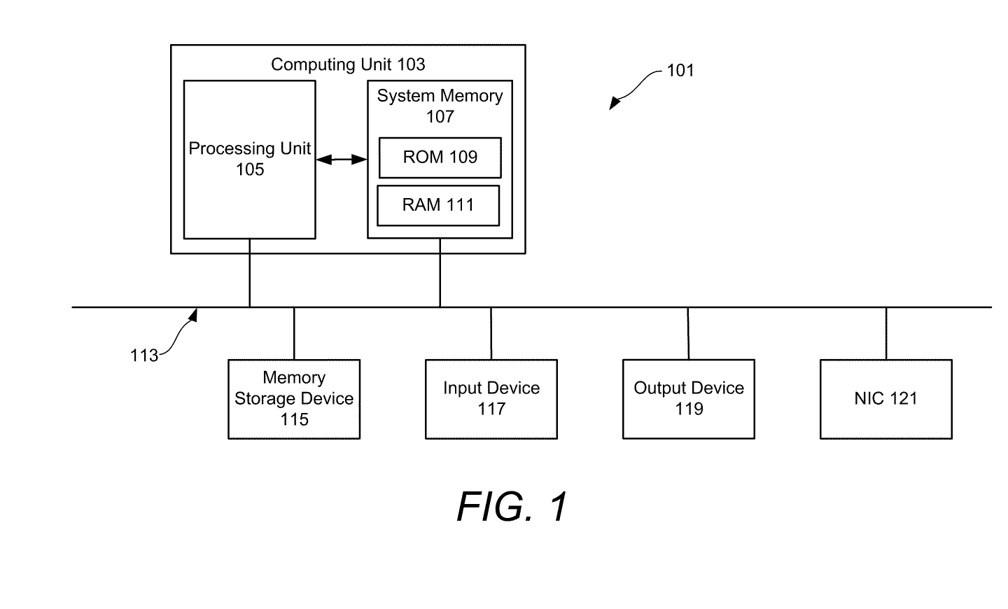

As the techniques of the present invention may be implemented using software instructions, the components and operation of a generic programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (“ROM”) 109 and a random access memory (“RAM”) 111. As will be appreciated by those of ordinary skill in the art, both the ROM 109 and the RAM 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (“USB”) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (“TCP”) and the Internet protocol (“IP”). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

Introduction

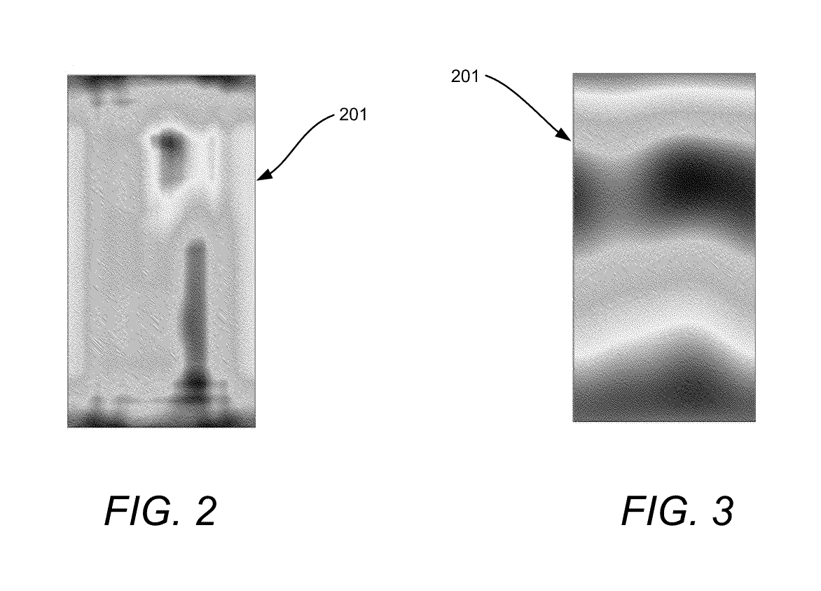

As stated above, etch induced pattern transfer has an affect over a large portion of the design. As a result, a full-chip analysis of the etch affects is often required for understanding the pattern dependency inherent in the etch step. FIG. 2 illustrates the distribution of the averaged pattern densities for a die 201. FIG. 3 illustrates the steady-state distribution of carbon fluoride and fluorine radical fluxes (i.e. ΣCF₄) caused by microloading in the case of silicon oxide etch with CF₄ plasma.

Many attempts have been made to understand the pattern density non-uniformity on the etch rate of the patterned wafer. More particularly, prior work has sought to capture the microloading effects at the chip design stage, that is to say, to take into account the process-induced critical dimension variations caused by the pattern density heterogeneity.

Linked multi-scale simulations were employed to address this complex problem [1-3]. These techniques employ a reactor scale model, which provides the flux distributions of all important species. When these distributions along with the species angular and energy distributions extracted from the appropriate sheath model are implemented in the feature scale simulations, the result of the linked multi-scale simulations provides the capability to capture the effects coming from the wafer-scale and aspect ratio related phenomena.

While this provides a somewhat suitable simulation model for various possible wafer scales, a suitable method to link the simulation models has not been provided yet. The significance of this is that with respect to die-level etch process modeling, there has been a missing link between reactor (or wafer) scale and feature scale simulations of the etch process. Because there is a 6-7 order-of-magnitude difference between the wafer and feature sizes, a die-level model is necessary as it provides a link between wafer and feature-scale simulation tools and a way to model layout-induced intra-die etch variation. All existing examples of the linked plasma etch models (see [1-3] and the literature sited there) while providing good results for some particular cases can not address the etch-induced critical dimension variations caused by pattern density heterogeneity for a real design.

Pattern Density Model Synopsis

We have developed a novel model-based full-chip algorithm capable to control the design specific variation in pattern transfer caused by via/contact etch processes. This physics based algorithm can detect and report the etch hotspots based on the fab defined thresholds of acceptable variations in a prospective dry etch process step. Physical model for the etch rate of an arbitrary feature, incorporated into the developed algorithm, takes into account both the phenomena: an across-die variation in radical fluxes caused by global PD variation (microloading) and aspect ratio (AR) induced variation in inter-feature radical transport resistance. Combining these two scales was possible by solution of the die-scale diffusion problem with the flux boundary conditions (BC) introduced on the “effective reaction surface”, which replaces the wafer surface reaction rate BC. The later was done by solution of the ballistic transport problem in the sub-surface sub-domain. This model is usable during the design and mask data preparation (MDP) stage for reducing the impact of pattern density induced etch variability. It can be used also as a tool for etch process optimization to capture the impact of a variety of patterns presented in a particular design on etch performance. Calculated etch rate variation provides recommendation for the design optimization and development of etch correction strategies either for the whole die or individual cell mask layout, which should be employed to avoid the possible yield loss associated with the etch step. A realistic set of process parameters employed by the developed model allows using VCE for the design aware process optimization in addition to the “standard” process aware design optimization (DFM). Employed physics-based modeling is the major difference between the developed approach and the previous rule based efforts to address non-uniform PD effects in etch processing at the design and MDP stages. Implemented link between reactor-scale and die-scale simulations allows capturing a pattern variation factor for process recipe optimization. Our approach is free from the necessity to introduce all the proximity factors separately. All the information about the die layout is implicit in the solution, so there is no need for the analyzed etch step to be run on a specially designed test chip.

The developed model and calculation algorithm for the across-die variations in etch rate and etched profile consist of the following segments: (1) determination of the across-die distribution of concentrations of all neutrals participating in etch reactions by means of solution of the corresponding diffusion (or diffusion-convection) equations with the flux BC describing the PD-dependent consumption of neutrals; (2) resolving the inside feature transport resistance for the radical fluxes in order to converge the radical flux impinging wafer surface into the flux reaching the etching surface at the feature bottom and sidewalls; (3) development of the etch rate formalism as a function of the of neutrals and ion energy fluxes; (4) development of the etch stop criterion for determination of the etched profile and bottom contour.

Mass-Balance Equation

Fluxes of different radicals coming from the plasma impinge a wafer surface. We assume that the flux of i-th radical impinging the photo-resist (PR) is consumed with a probability χⁱ_{PR}. A probability to be consumed by the etch reactions inside a feature is χⁱ (χⁱ can be an AR dependent parameter). It is easy to show [4] that in this case the flux reflected by wafer per unit area per unit time through the solid angle dΩ in a direction θ is

$${\tilde{Γ}}^{i} ( {r}_{1} , {φ}_{1} , θ ) = \frac{{Γ}_{0}^{i}}{π} ( ( 1 - {χ}_{PR}^{i} ) ( 1 - ρ ( {r}_{1} , {φ}_{1} ) ) + ( 1 - {χ}^{i} ( AR ) ) ρ ( {r}_{1} , {φ}_{1} ) ) cos θsin θ d θ d {φ}_{1} \qquad ( 1 )$$

where ρ(r₁,φ₁) equals to 1 everywhere inside the etched features and 0 at the PR surface, Γ₀ⁱ=Nᵢcᵢ/4 is the thermal flux. Here cᵢ is the gas thermal velocity and Nᵢ(\vec{r}) is the concentration of i^{th} radical. Hence, the density of the flux of consumed neutrals, which is the difference of the densities of incoming and reflected fluxes depends on PD. Spatial variation in neutral flux consumed by the etch reactions results in variation in neutrals concentration in the near surface area. Diffusion of radicals works against this variation trying to alleviate its concentration. As a result the steady state distribution of radicals is developed. In order to determine the neutrals distribution a mass balance equation linking the neutrals generation and decay in the plasma bulk reactions, consumption by etch related chemical reactions and exchange with the neighboring plasma regions by diffusion (and convection) should be solved.

Continuum model of the chemical species transport is not applicable in the scales below λ, which is a mean free path of a particular radical. To avoid this problem an effective “reaction surface”, located above real wafer surface at a distance h˜λ, should be introduced [1]. A flux BC at the “reactive” surface, which is introduced to account etch-induced radical consumption, takes the following form:

$$Γ = \frac{{N}_{i} ( \vec{r} ) {c}_{i}}{4} \frac{{h}^{2}}{π} {\int }_{0}^{2 π} {\int }_{0}^{∞} ( {χ}_{PR}^{i} ( 1 - ρ ( {r}_{1} , {φ}_{1} ) ) + {χ}^{i} ( AR ) ρ ( {r}_{1} , {φ}_{1} ) ) \frac{{r}_{1} d {r}_{1} d {φ}_{1}}{{( {h}^{2} + {\vert {\vec{r}}_{1} - \vec{r} \vert}^{2} )}^{2}} \qquad ( 2 )$$

Similarly to Stenger [5], by averaging the diffusion equations along the plasma thickness (L), with the flux BC, given by (2), and assuming that diffusion is much faster than the gas flow, we can get the differential equation for each radical Nᵢ(\vec{r}) distribution at the “reactive surface”:

$$0 = D \{ [ \frac{{\partial }^{2} {\overline{n}}_{i}}{\partial {r}^{2}} + \frac{1}{{r}^{2}} \cdot \frac{{\partial }^{2} {\overline{n}}_{i}}{\partial {φ}^{2}} + \frac{1}{r} \cdot \frac{\partial {\overline{n}}_{i}}{\partial r} ] \} - \frac{{\overline{n}}_{i} \overline{c} F ( r , φ )}{4 L} + γ - {k}_{V} {\overline{n}}_{i} \\ F ( r , φ ) = \int \hat{χ} ( {\vec{r}}^{′} + \vec{r} ) ρ ( {\vec{r}}^{′} + \vec{r} ) \frac{{d}^{2} {\vec{r}}^{′}}{{( 1 + \frac{{\vec{r}}^{′2}}{{h}^{2}} )}^{2}} \\ \hat{χ} ( {\vec{r}}^{′} ) = \{ \begin{matrix}χ \\ {χ}_{PR}\end{matrix} \} , \qquad ( 3 )$$

where,

$${\overline{n}}_{i} ≡ \frac{1}{L} {\int }_{- L / 2}^{L / 2} {N}_{i} d z ,$$

is the Nᵢ-radical concentration averaged across the reactor thickness, γ is the gas phase rate of the N-radical generation, kᵥ n̅ᵢ is the homogeneous loss of this radical. Due to complex character of the parameter dependency on plasma recipe as well as the of difference in generation rates for different radicals it is reasonable to introduce a dimensionless form for radical concentration:

$$θ = \frac{\overline{n}}{( \frac{{γλ}^{2}}{D} )} . \qquad ( 4 )$$

The transformation to the normalized concentration leads to the dimensionless form of the mass balance equation (3):

$$1 - θ ( \vec{r} ) ( \frac{1}{{θ}_{0}} + \frac{3}{4} \frac{λ}{L} F ( \vec{r} ) ) + {λ}^{2} Δ θ ( \vec{r} ) = 0 , \qquad ( 5 )$$

### Here,

$${n}_{0} = \frac{γ}{{k}_{V}} and {θ}_{0} = {n}_{0} / ( \frac{γ {λ}^{2}}{D} ) = \frac{\overline{c} {n}_{0}}{3 γ λ} .$$

### Both

$$\frac{1}{{θ}_{0}} and \frac{3}{4} \frac{λ}{L}$$

are dimensionless parameters. Parameters n₀ and θ₀ describe the radical saturation concentration (in dimension and dimensionless forms correspondingly) which can be achieved when etch is suppressed. They equal to the ratio of radical generation rate and its gas phase decay. Both the rates are functions of many unknown plasma parameters. Everywhere further, we keep 1/θ₀ as a small tuning parameter.

Solution of these mass balance equations generates across-die distributions of concentrations of all radicals participating in etch reactions. Pattern density dependency is introduced by F(r,φ). Gas-kinetic properties of radicals (D, λ, c) are calculated based on Chapman-Enskog kinetic theory [4].

Taking into account simple geometrical relations, a final flux is calculated as the flux of radicals coming from the reactive surface and reaching a wafer surface of a unit square at location \vec{r}:

$$Γ ( \vec{r} ) = \int \frac{n ( \vec{r} + {\vec{r}}^{′} ) \overline{c}}{4} G ( {\vec{r}}^{′} ) {d}^{2} {\vec{r}}^{′} , \\ where \\ G ( \vec{r} ) = \{ \begin{matrix}\frac{1}{π {h}^{2}} \frac{1}{{( 1 + {\vec{r}}^{2} / {h}^{2} )}^{1.5}} ; & \vert r \vert \leq λ \\ 0 ; & \vert r \vert > λ .\end{matrix} \qquad ( 6 )$$

### Substituting

$$n ( \vec{r} ) = θ ( \vec{r} ) ( \frac{{γλ}^{2}}{D} ) = θ ( \vec{r} ) \frac{3 γλ}{\overline{c}}$$

into (6) we can get:

$$Γ ( \vec{r} ) = \frac{3}{4} γλ \int θ ( \vec{r} + {\vec{r}}^{′} ) G ( {\vec{r}}^{′} ) {d}^{2} {\vec{r}}^{′} ,$$

and finally for the normalized flux of radical we can write:

$${γ}_{n} ( \vec{r} ) = \frac{Γ ( \vec{r} )}{{Γ}_{0}} = \frac{\int θ ( \vec{r} + {\vec{r}}^{′} ) G ( {\vec{r}}^{′} ) {d}^{2} {\vec{r}}^{′}}{{θ}_{0}} , \qquad ( 7 )$$

where,

$${Γ}_{0} = \frac{3}{4} {γλθ}_{0} .$$

Thus, solution of the described above differential equations provides the fluxes of all radicals coming to every point of the analyzed layout. In two limiting cases corresponding to: the entire wafer covered by photo resist, i.e. when no etch-induced radical consumption takes place (i), and to the completely open wafer, i.e. when entire wafer surface is etched (ii), we have:

θ(\vec{r})=θ₀ and γₙ(\vec{r})=γₙ^{max}=1 (i)

for the former case, and

$$θ ( \vec{r} ) = {θ}_{1} = \frac{1}{\frac{1}{{θ}_{0}} + \frac{3}{4} \frac{λ}{L}} \\ and \\ {γ}_{n} ( \vec{r} ) = {γ}_{n}^{min} = \frac{1}{1 + \frac{3}{4} \frac{λ}{L} {θ}_{0}} \approx \frac{4}{3} \frac{L}{λ} \frac{1}{{θ}_{0}} << 1 \qquad ( ii )$$

for the last one.

The developed physics-based model enables flux calculation at any point, assuming that the plasma parameters involved in the model (i.e. mean free path of radicals λ, radical generation and loss rates γ and kᵥ) are known. However, while the parameter λ depends primarily on the gas composition, pressure and operating temperature and can be easily determined for a specified process, the parameters γ and kᵥ (presented in the model by the combined parameter θ₀) can depend on many different factors and can be obtained only from calibration. The calibration of VCE model is a rather complicated procedure, since no data on radicals' concentration/flux distributions across the die can be obtained experimentally. The only available measured data that can be used for the model calibration and validation are the etched feature geometry such as top and bottom CD, etch depth, side-wall slope, etc. measured at different locations on the die. It should be mentioned that etch depth variation can be extracted from measurements on a “half-etched” wafer, where etch was stopped before etching through the whole layer. With this purpose, we must combine the microloading model with the physical model describing the etch profile propagation. It can be done when the etch mechanism is established and the inter feature resistance to the radical transport is taken into account.

Formalism of SiO₂ Etch by Fluorocarbon Plasmas

Via etch in silicon oxide by means of fluorocarbon plasma was used for validation of the developed model. Plasma assisted etch of silicon dioxide is the processes characterized by the complex mechanism. It involves different type of reactive species and different type of surface phenomena such as radical generation, polymer deposition and removal, ion energy transfer through the polymer layer, physical sputtering, etc. (see for example the review [6] and the reference there). Fluorocarbons plasmas are able to supply both the ions and radicals necessary for SiO₂ etch. Fluorocarbon radicals (CF, CF₂, CF₃, etc.) produced in a plasma form fluorocarbon films on all the surfaces exposed to the plasma. These layers can protect these surfaces against the interactions with the plasma. Fluorocarbon ions, as well as ions of other gases present in the gas mixture, escaping the plasma bulk deliver the energy needed for activation of the SiO₂ etch reactions. Mutual actions of these radicals and ions result in the SiO₂ etch. The thickness of a fluorocarbon layer (CₓF_{y}) determines the etch rate of underlying SiO₂. In other word, the balance between deposition and etching of carbon atoms on the surface determines the thickness of the CₓF_{y} layer. This concept of silicon oxide etching was proved by experimental results of Tatsumi et al [7,8]. Reaction scheme for the SiO₂ etch by the fluorocarbon plasma can be described as following Figure:
CFₓ radical fluxes result in CₓF_{y} polymer deposition
O-atom flux is a major cause of the polymer removal
Precursors for the etch-related reactions are formed at the polymer-SiO₂ interface by ion-induced energy transfer: “—Si—O—”+E=“Si—”+“O—”. Energy flux is controlled by the polymer thickness.
Solid-state chemical reactions between “activated” Si— and O— from SiO₂ and F— and C— from polymer or coming directly from plasma are responsible for the silicon oxide etch (solid state reactions) and the additional polymer thickness reduction.

Depending on polymer film thickness two etch regimes can be distinguished. In the case of “thin polymer” the deceleration of ions by polymer is negligible. Etch rate increases with increase of CFₓ flux. In the “thick polymer” regime the ion energy supply to SiO₂ surface is limited and the activated layer is “depleted”. In this case an increase in CFₓ flux results in thickening of deposited polymer and the etch rate decreases. Oxygen and fluorine atoms incident from the plasma reduce the polymer layer thickness, maintaining the high etch rate. It should be noted that the polymer deposition takes place on the specially activated surface only [9]. This activation is produced by low energy ions coming from the plasma. Based on this fact, it is clear that the polymer layer developed on the almost vertical sidewalls of the etched features is characterized by the fixed thickness because of a lack of ion impingement.

Ion-Energy Transfer through C—F Polymer Layer

In order to activate the etch reactions ions should be able to penetrate the polymer layer and to bring enough energy to the (C—F)—SiO₂ interface for the siloxane (Si—O) bond cleavage. Thus, we need to estimate an ion energy flux delivered to the interface for given polymer thickness and the energy of the incident ion.

It is known that an incident ion is stopped in the target material by a combination of the elastic collisions and electronic interactions (see, for example, [10] and the literature cited there). The energy loss along the original ion trajectory may be calculated from

$$- \frac{\partial E}{\partial x} = {NS}_{n} ( E ) + {NS}_{e} ( E ) \qquad ( 8 )$$

Here, N is the atom density, Sₙ(E) is the nuclear stopping power and Sₑ(E) is the electronic stopping power. In order to estimate the ion penetration range in the compound material, the stopping powers are calculated first for each target component (for example, C and F in the case of CₓF_{y} target). Then the energy loss is calculated as if the target contained only one type of atoms with a density equivalent to this type of atoms in compound. The total stopping power is the sum of the stopping powers for each atom type in the compound. At low ion energies below those used for ion implantation, the nuclear stopping power is a function of the ion energy, characterized by different dependencies for different energy regions. At very low energies (less than a few hundred eV) the stopping power is proportional to E. At higher energies, but below a few keV, which is the energy of interests, the stopping power is proportional to E^{1/3}.

$${S}_{n} ( E ) = 10.6 \frac{{( {Z}_{1} {Z}_{2} )}^{\frac{2}{3}}}{{( \sqrt{{Z}_{1}} + \sqrt{{Z}_{2}} )}^{\frac{8}{9}}} {( \frac{{M}_{1}}{{M}_{2}} )}^{\frac{1}{3}} \frac{4 {M}_{1} {M}_{2}}{{( {M}_{1} + {M}_{2} )}^{2}} {E}^{\frac{1}{3}} . \qquad ( 9 )$$

For the electron stopping power we have [10]:

$${S}_{e} ( E ) = 3.84 {e}^{- 15} {Z}_{1}^{\frac{1}{6}} ( \frac{{Z}_{1} {Z}_{2}}{Z} ) {( \frac{E}{{M}_{1}} )}^{\frac{1}{2}} \qquad ( 10 )$$

Here, M₁ and Z₁ are the incident ion mass and atomic number, and M₂ and Z₂ are the target component atom mass and atomic number. Approximate solution of the equation (8) with the parameters given by (9) and (10) provides

$$E ( H ) = {{E}_{0} ( 1 - \frac{κ}{{E}_{0}^{\frac{1}{3}}} H )}^{3} \approx {E}_{0} ( 1 - \frac{H}{{H}^{*}} ) , \qquad ( 11 )$$

where, k is a function of the properties of incident ion and target material. H* is the critical polymer thickness preventing it penetration by the ions with energy E₀ and smaller. Calibration of the obtained expression (11) for energy loss in the polymer layer against Tatsumi's data [8], provides

$$E ( H ) \approx {{E}_{0} ( 1 - 0.39 {E}_{0}^{- \frac{1}{3}} H )}^{3} \approx {E}_{0} ( 1 - \frac{1.14}{{E}_{0}^{\frac{1}{3}}} H ) \qquad ( 12 )$$

It should be noted that linearization is valid in the energy-thickness region far from the etch stop. Figure demonstrates the correspondence between experimental data and model predictions.

Mathematical Formulation of the Etch Mechanism

We assume:
the polymer layer thickness is determined by the accumulation of carbon atoms. Polymer structure is generated by carbon cross-linking reactions. Carbon having two or four valence electrons forms a network of C—C bonds, which makes the film dense.
Fluorine atoms having only one valence electron terminate the carbon network making film sparse.
Carbon atoms are deposited by CFₓ radical and ion fluxes [11]. For the simplicity we consider that the major mechanism of polymer layer deposition is the CF₂ flux. It is related to the highest reactivity of CF₂ in SiO₂ surface reactions [12] and the highest value of the CF₂ radical flux toward the wafer surface compared with the other CFₓ species.
We model carbon removal from the polymer layer by its reaction with oxygen atoms coming from gas phase as well as generated at the polymer-SiO₂ interface by siloxane bond cleavage.

It was experimentally demonstrated in [8] that the blanket silicon oxide etch rate (ER) and the thickness of the polymer layer (H) are characterized by non monotonic dependency on the flow rate of the feed gas (C₄F₈ in this particular case) and, hence, on the CF₂ flux [8]. Such type of dependencies was explained by the following:

Thin polymer layer (H<1 nm). ER increases with the CF₂ flux increase while the thickness of C—F layer is almost not changing. It is related to the absence of a real polymer film on the SiO₂ surface. The C—F layer is rather represented by a poly-layer of adsorbed species participating in various chemical reactions resulting in SiO₂ etch. Ion energy easily reaches the interface and forms a large number of “active” silicon and oxygen species reacting with the F and C atoms of the adsorbed radicals. In this case the etch rate is limited by the supply of F and C reagents (low C₄F₈ flow rate results small CFₓ fluxes).

Transition area. Increase in C₄F₈ flow results in thicker C—F layer. Thick polymer layer creates a barrier for the ion energy supply to the interface that results in depletion in the “active” silicon and oxygen precursors. This “depletion” reduces the ER and is responsible for the further increase in the thickness of C—F layer.

Based on all said above we can assume that two different models should be applied in order to describe these two cases. It should be noted that etch engineers try to optimize the recipe to reach the etching conditions of “thin polymer” region in order to obtain a smooth surface and a high etch rate [13]. At the same time for those locations where etch was stopped the etching conditions (relations between fluxes, energy and polymer thickness) are belonged to the extension of the “thick polymer” region toward the zero etch rate [8].

Kinetics of the density of carbon (x_{C}) and fluorine (x_{F}) inside the adsorbed layer and the density of “active” silicon and oxygen at the interface (θ) can be described by the following system of differential equations:

$$\frac{\partial {x}_{C}}{\partial t} = {k}_{D} {Γ}_{{CF}_{2}} - {k}_{R} {x}_{C} {Γ}_{O} - {k}_{etch}^{C} {x}_{C} θ \\ \frac{\partial {x}_{F}}{\partial t} = {k}_{D} {Γ}_{{CF}_{2}} - {k}_{etch}^{F} {x}_{F} θ \\ \frac{\partial θ}{\partial t} = η F ( H ) ( 1 - θ ) - {k}_{etch}^{C} {x}_{C} θ \\ F ( H ) = {Γ}_{i} {E}_{0} ( 1 - \frac{{M}_{C}}{{ρ}_{S} {H}^{*}} {x}_{C} ) \\ H = \frac{{x}_{C} {M}_{C}}{{ρ}_{S}} \qquad ( 13 )$$

Here, F(H) is the ion energy flux penetrated the C—F layer of the thickness H, E₀ is the incident ion energy, M_{C} is the carbon molecular weight, ρ_{S} is the C—F layer density, H*=E₀^{1/3}/μ is the maximal penetration depth for ions with the incident energy E₀ in the C—F layer. Γ_{CF2}, Γ_{O} and Γᵢ are the CF₂, O and ion fluxes. The first terms in the left hand side of the first two equations describe the carbon and fluorine deposition. The second and third terms in the first equation are the removal of carbon atoms by means of reaction with oxygen atoms coming from the plasma and released in the course of SiO₂ etch. The second term in the second equation is the etch reaction between silicon and fluorine. The third equation describes the kinetics of the “active” silicon-oxygen pairs: generation by consumption of energy delivered by ion flux and decay by means of etch reactions: Si+F=>SiF₂ (SiF₄) and O+C=>CO.

In the “thin polymer” regime (which is optimal for via etching), the etch rate (ER) of SiO₂ in the oxygen-rich plasmas depends on CF₂ and O fluxes at the via bottom Γ_{CF2} and Γ_{O} as follows:

$$ER \approx {K}_{etch} {k}_{D} {Γ}_{{CF}_{2}} ( 1 - \frac{{k}_{etch} {k}_{D} {Γ}_{{CF}_{2}}}{η {E}_{ion} ( {k}_{R} {Γ}_{O} + {k}_{etch} )} ) \qquad ( 14 )$$

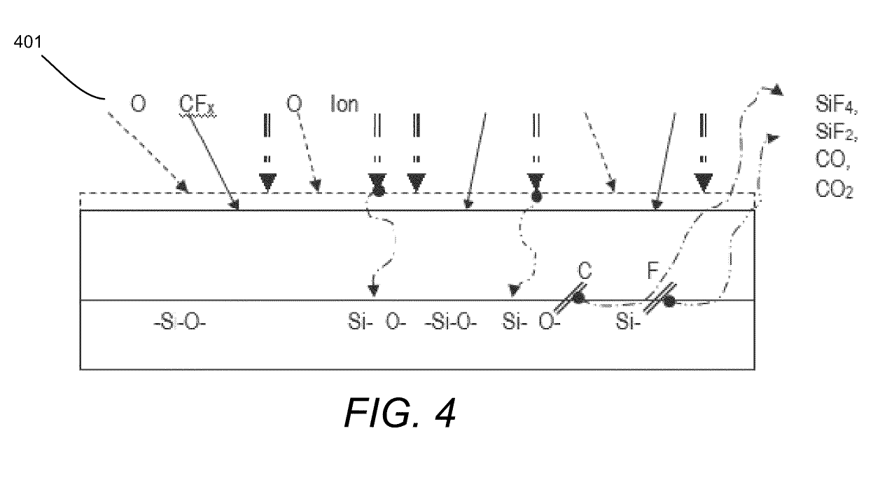

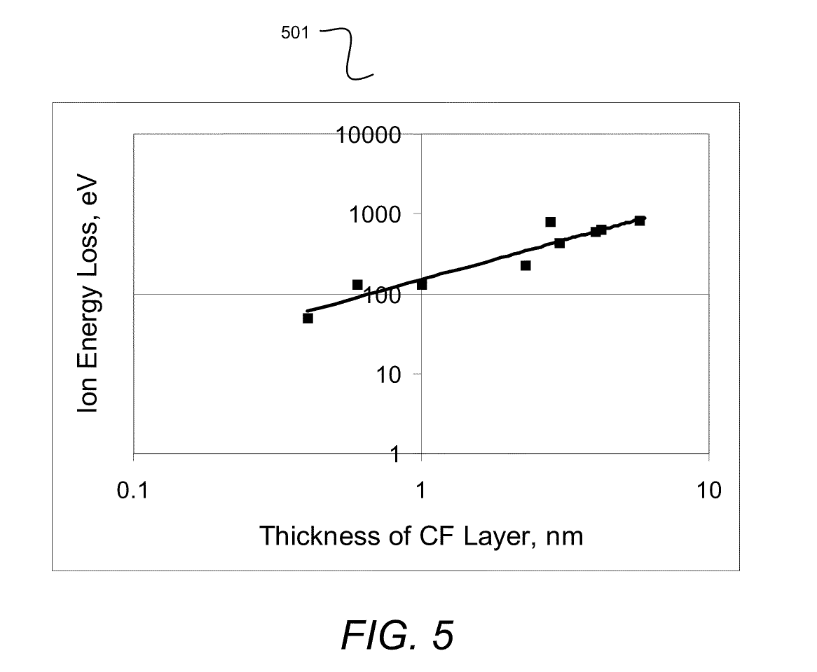

Here k_{D} and k_{R} are the rates of polymer deposition and removal respectively, coefficients η and k_{etch} are the rates of SiO₂ surface activation and the reaction between fluorine and silicon, K_{etch} characterizes a volume of material removed per the reaction step. All these parameters are process-dependent and must be obtained from calibration, along with the parameter θ₀. FIG. 4 shows predicted SiO₂ etch rate as a function of ion energy and amount of oxygen in the gas mixture vs. Tatsumi's data [7]. The locations at the etch profile, which obtain the smaller flux-numbers of oxygen atoms, are characterized by thick polymer coverage. FIG. 5 shows the polymer thickness and SiO₂ etch rate as a function of ion energy and amount of oxygen in the gas mixture upon calibration on Tatsumi's data [7] for “thick polymer” regime.

Etch is stopper upon reaching the critical condition which is described as:

$$\frac{{k}_{D} {Γ}_{{CF}_{2}}}{{k}_{R} {Γ}_{O}} = \frac{{ρ}_{S}}{{M}_{C}} \frac{{E}_{0}^{\frac{1}{3}}}{μ} \qquad ( 15 )$$

This “etch stop” condition interrelates the fluxes of radicals that build up the polymer layer with the fluxes of radicals that etch the polymer and with the energy of the incident ions. These fluxes should be taken at the location where etch is occurring. If it is a feature (via, trench, etc.) bottom then we should consider Γ_{CF2} and Γ_{O} as the fluxes reaching the bottom of the etched feature. This condition provides a position of the bottom contour of etched feature.

Inter-Via Radical Transport

The transportation of the incident radicals to the bottom of the etched vias depends strongly on the feature aspect ratio, and on ability of radicals to adhere to the surfaces [14]. The transport mechanisms are different for oxygen and fluorocarbon radicals, since they have different probabilities of sticking to the surfaces covered by fluorocarbon film. We assume that the oxygen atoms react readily with this film, i.e. the atom incident on the via sidewall has almost no chances to reach the bottom. Therefore, oxygen flux reaching the via bottom is determined purely by ballistic transport of particles. For each point r on the via bottom the oxygen flux can be calculated with the following expression

$${Γ}_{O}^{bot} = \frac{1}{2 π} {\int }_{Ω ( r )} {\overline{c}}_{O} {n}_{O} ( θ , ϕ ) sin θ d θ d ϕ \qquad ( 16 )$$

where the solid angle Ω(r) defines the segment on reactive surface which is “visible” from the point r at the via bottom.

As it was mentioned above, sticking of fluorocarbon radicals CF₂ to the feature surface covered by polymer depends on intensity of the polymer treatment by the low-energy ions incident from plasma bulk [9]. Due to small angular distribution of the ion flux mainly the polymer covering the via bottom is exposed to direct ion flux, which activates the polymer and promotes deposition of new CF₂ radicals. Meanwhile, the polymer on sidewalls remains inactivated, and the incident CF₂ particles can be “re-emitted”. Therefore, these radicals penetrate into the high aspect-ratio features more easily than oxygen, since along with “direct-visibility” flux an additional flux to the bottom is provided by the re-emission of particles from sidewalls. In this case the flux at the via bottom can be estimated by approximating the transportation of particles as Knudsen diffusion, well-known in kinetic theory of gases [4]. Having calculated the average flux of CF₂ particles incident the top of via:

$${Γ}_{{CF}_{2}}^{top} = \frac{1}{2 π} {\int }_{Ω} {\overline{c}}_{{CF}_{2}} {n}_{{CF}_{2}} ( θ , ϕ ) sin θ d θ d ϕ \qquad ( 17 )$$

we can then evaluate the uniform flux at the bottom of cylindrical via (with top radius R) as

$${Γ}_{{CF}_{2}}^{bot} = \frac{{Γ}_{{CF}_{2}}^{top}}{1 + \frac{3}{8} \frac{h}{R}} . \qquad ( 18 )$$

The solid angle Ω in the expression (17) is determined now only by the mean-free-path of the radical λ_{CF}_{₂}, since there is no shadowing effect for the flux at top of the via. From the simple estimation based on expressions (16) and (17) we can see that the flux of oxygen atoms at the via bottom is defined as Γ_{O}^{bot}≈Γ_{O}^{top}(h/R)², while for CF₂ radicals the relation Γ_{CF}_{₂}^{bot}≈Γ_{CF}_{₂}^{top}(h/R) is valid. Using these relations, we can re-write the ER as

$$ER \approx {K}_{etch} {k}_{D} {Γ}_{{CF}_{2}} ( 1 - \frac{{k}_{etch} {k}_{D} 〈 {Γ}_{{CF}_{2}} 〉 {γ}_{{CF}_{2}} ( 1 + \frac{3 h}{8 R} )}{η {E}_{ion} ( {k}_{R} 〈 {Γ}_{O} 〉 {{γ}_{O} ( \frac{h}{R} )}^{2} + {k}_{etch} )} ) . \qquad ( 19 )$$

Here, <Γ_{CF}_{₂}> and <Γ_{O}> are the averaged across the die values of fluxes which should be determined from the calibration. Across-die via-to-via ER variation governs by variations in the normalized fluxes γ_{O} and γ_{CF2}.

Calibration and Parameter Optimization

In order to predict ER for any particular via in the analyzed design a calibration of all unknown parameters should be performed. This calibration procedure assumes an availability of post-etch via geometries, such as an etch depth, a bottom CD, etc., measured at different locations on the die. A number of measurements should be not less than the number of unknown parameters. Besides that, as it follows from (19), ER depends strongly on the via top radius R, which can vary due to lithography issues. Therefore, measurements of Rᵢ developed during the time t_{etch} are required for calibration. If measurements of the via depths Hᵢ are used for calibration then for any via the relation between the etch time and etch rate is defined by the following integral equation

$${t}_{etch} = {\int }_{{h}_{PR}}^{{h}_{PR} + {H}_{i}} \frac{d h}{{ER}_{i} ( h )} \qquad ( 20 )$$

where h_{PR} is the photo-resist thickness, which varies during the etching due to photo-resist sputtering. The sputtering rate Rₛ was extracted from the experimental data on etch selectivity, and was used to model the photo-resist thickness as: h_{PR}(t)=h_{PR}(0)−Rₛ·t for the better calibration accuracy.

A calibration procedure was developed for optimization θ₀ and all other model parameters. A set of equations (20) for n vias was solved, using the calculated values of normalized fluxes γ and measured values of via sizes and etch depths. The later data were provided by the TEM measurements. Optimization of all parameters was done on the basis of best fit between the measured and predicted via depths Hᵢ. The depths of all vias h(t_{etch}) existing in the layout were calculated using the following differential equation, where ER(h) was updated with the optimized parameters:

$$\frac{\partial h}{\partial t} = ER ( h ) \qquad ( 21 )$$

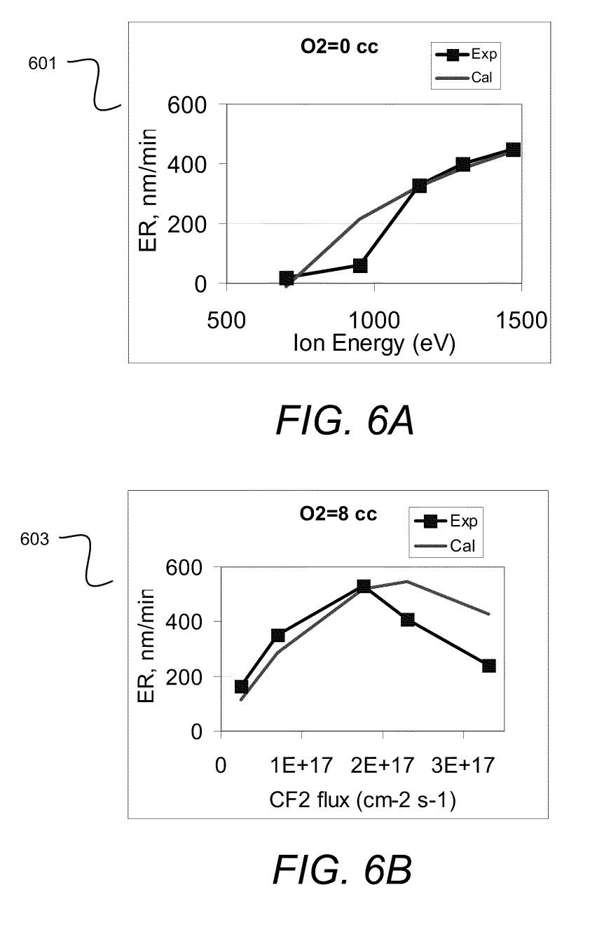

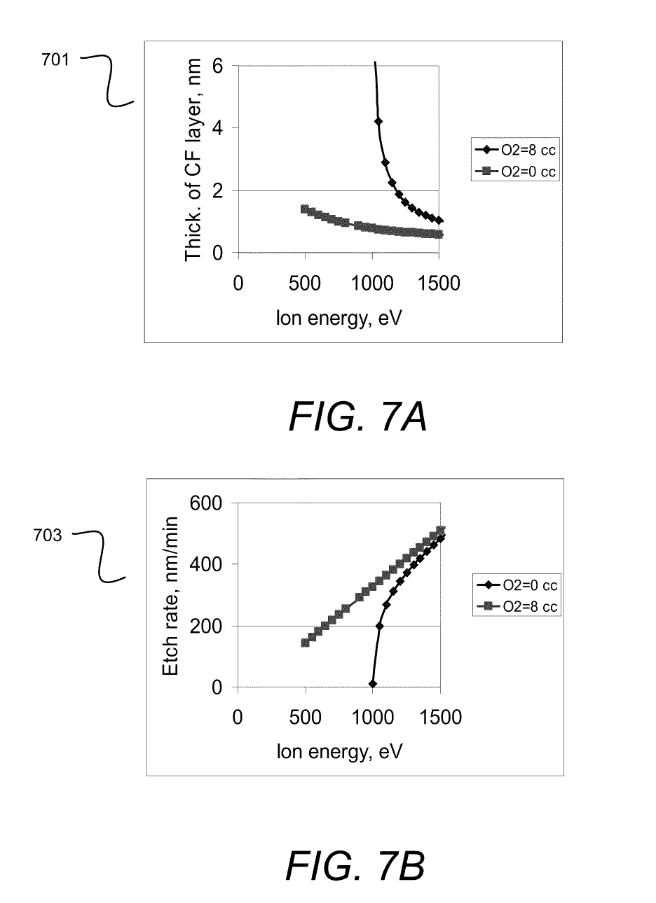

On the basis of calibrated model, etch depths were predicted for 28 vias (18 vias having design size of 67 nm, and 10 vias with the size of 110 nm), located in regions characterized by different pattern densities. The correlation between measured and predicted values is presented on FIG. 6. FIG. 7 demonstrates the achieved fit between measured and calculated depths.

It should be noted that employed method of calibration restricts the VCE predictability to the specific etcher with specific process recipe where measured features were etched. Separate calibrations should be done for different pieces of equipment and different process recipes.

Use Models and Applications

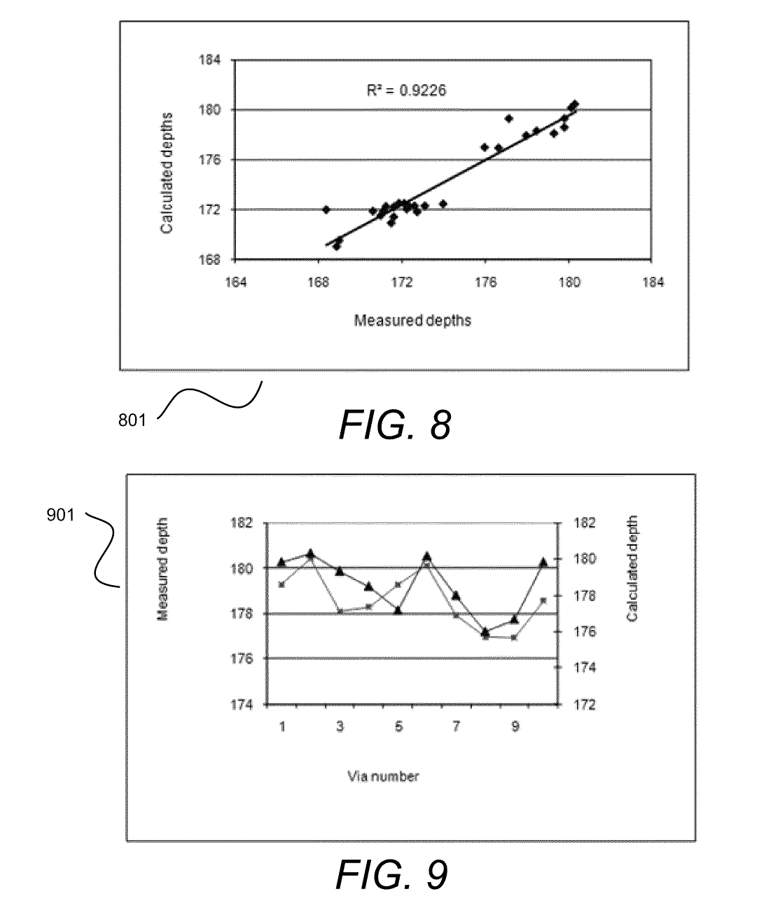

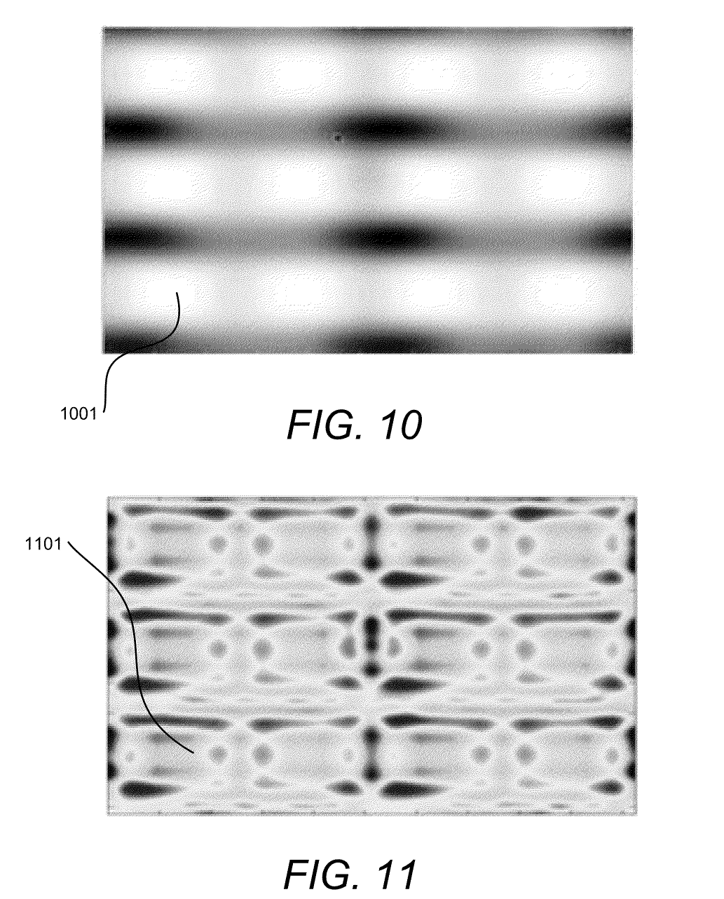

A novel simulation tool was developed on the basis of described algorithm. It has a capability to predict layout-induced variation in pattern transfer by dry etch process. This predictability can be employed in different applications and creates a solid basis for a number of use-models. As an example of such application we can consider a detection of etch-induced hot spots in a particular design. FIG. 8,a demonstrates the color map of the across-die radical flux-number distributions calculated for the considered design. By introducing the treshold etch rates as conditions for via under- and over-etch we can request the code to find locations of all suspicious vias which can result in a catastrophic failure. FIG. 8,b demonstrates a bottom CD distribution generated by VCE for this design. VCE can predict via/contact bottom CD variation for every step of a multistep etch receipe and report the etch hotspots based on the fab defined thresholds of acceptable variations in a prospective etch step. Different correction scenarios that should be undertaken either from design side or manufacturing can be evaluated with this tool. Smart dummy insertion based on the VCE analysis or adjustment of a drawn in GDSII CD size for specific via/contact locations determined by VCE at the MDP stage are examples of the design related correction. Another possible way is the design-specific optimization of process parameters by employing VCE linked with the robust reactor-scale model. Modification of the plasma gas-phase composition caused by process paramets adjustment, calculated in the reactor-scale model, provides VCE with the modified values of internal code parameters such as λᵢ, θ₀ⁱ, etc., which generates modified radical flux distributions and a result in the etch-induced change in the botom-CD distribution.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

### APPENDIX

The following references are all incorporated herein by reference, and may be referred to in the specification above.

1. Hasper, A., Holeman, J., Middelhoek, J., Kleijn, C. R. and Hoogendorn, C. J., “Modeling and optimization of the step coverage of Tungsten LPCVD in trenches and contact holes,” J. Electrochem. Soc. 138, 1728-1738 (1991).

2. Gobbert, M. K., Ringhofer, C. A. and Cale, T. S., “Mesoscopic Scale Modeling of Microloading during Low Pressure Chemical Vapor Deposition,” J. Electrochem. Soc., 143, 2624-2631 (1996).

3. Rodgers, S. and Jensen, K., “Multiscale modeling of chemical vapor deposition,” J. Appl. Phys., 83, 524-530 (1998).

4. Bird, R. B., Stewart, W. E. and Lightfoot, E. N., [Transport Phenomena], 2nd Ed., John Wiley & Sons, Inc. (2002).

5. Stenger, H. G. Jr., Caram, H. S., Sullivan, C. F. and Russo, W. M. “Reaction Kinetics and Reactor Modeling of Plasma Etching Silicon,” AIChE Journal, 33, 1187-1190 (1987).

6. Gottscho, R. A. and Jurgensen, C. W., “Microscopic uniformity in plasma etching”, J. Vac. Sci. Technol. B, 10, 2133-2147 (1992).

7. Matsui, M., Tatsumi, T. and Sekine, M., “Relationship of etch reaction and reactive species flux in C₄F₈/Ar/O₂ plasma for SiO₂ selective etching over Si and Si₃N₄,” J. Vac. Sci. Technol. A 19, 2089-2096 (2001).

8. Tatsumi, T., Matsui, M., Okigawa, M. and Sekine, M., “Control of surface reactions in high-performance SiO2 etching,” J. Vac. Sci. Technol. B 18, 1897-1902 (2000).

9. Han, J. S., McVittie, J. P. and Zheng, J., “Profile modeling of high density plasma oxide etching,” J. Vac. Sci. Technol. B 13, 1893-1899 (1995).

10. Middleman, S. and. Hochberg, A. K., [Process Engineering Analysis in Semiconductor Device. Fabrication.], McGraw-Hill, Inc., (1993).

11. Tanaka, J., Abrams, C. F. and Graves, D. B., “New C—F interatomic potential for molecular dynamics simulation of fluorocarbon film formation,” J. Vac. Sci. Technol. A 18, 938-945 (2000).

12. Jenichen, A., “Ab initio calculations to the reactions of CFₘ (m=4−1) and NFₙ (n=3−1) species with models of SiO₂ surface structures,” Surf. Sci., 331-333, 1503-1507 (1995).

13. Tatsumi, T., Urata, K., Nagahata, K., Saitoh, T., Nogami, Y. and Shinohara, K., “Quantitative control of etching reactions on various SiOCH materials,” J. Vac. Sci. Technol. A 23, 938-946 (2005).

14. Misaka A. and Harafuji, K., “Simulation study of micro-loading phenomena in silicon dioxide hole etching,” IEEE TED, 44, 751-760 (1997).

1. (canceled)

2. A computer-implemented method for simulating an optical lithographic process comprising:
receiving at least a portion of a layout pattern to be printed on a substrate through an optical lithographic process;
identifying a resist function that approximates at least the resist component of the optical lithographic process by relating an intended image to a simulated resist image;
identifying an etch function that approximates the etch component of the optical lithographic process by relating a simulated resist image to a simulated etched image, the etch function having a transport kernel and a visibility kernel;
deriving on a computer a simulated resist pattern by solving the resist function for the portion of the layout pattern; and
deriving on the computer a simulated etched pattern by solving the etch function for the simulated resist pattern.
